(19) United States
(12) Patent Application Publication
(10) Pub. No.: US 2017/0057678 A1
(43) Pub. Date: Mar. 2, 2017

(54) Method and Device for Producing Molded Parts from a Continuous Fiber-Material Sheet

(71) Applicant: Technische Universität Dresden, Dresden (DE)

(72) Inventors: Marek Hauptmann, Dippoldiswalde OT Seifersdorf (DE); Tobias Müller, Dresden (DE)

(21) Appl. No.: 15/308,371

(22) PCT Filed: Apr. 30, 2015
(86) PCT No.: PCT/DE2015/100175

§ 371 Date: Nov. 2, 2016

(30) Foreign Application Priority Data
May 8, 2014 (DE) 10 2014 106 427.5

(51) Int. Cl. B65B 47/04; B65B 61/06; B65B 7/16; B31F 1/00; B31B 1/60

(52) U.S. Cl. CPC B65B 47/04; B31F 1/0077; B31B 1/60; B65B 7/16; B65B 61/06; B31B 2201/223; B31B 2217/06

(57) ABSTRACT

The invention relates to a method and a device for producing three-dimensional molded parts from a continuous sheet of a flat, plastically malleable fiber material via deep drawing with a stamp and an associated die, wherein the fiber material between the stamp and the die can be reshaped via a relative movement.

The object of the instant invention is to offer a method and a device for producing three-dimensional molded parts in which the reshaping is done via deep drawing from a cut-to-size section in the continuous sheet and which leads to a high reshaping ratio. The problem is solved by connecting the round, rectangular, oval or irregular cut-to-size section for the molded part during the deep-drawing process to the continuous sheet of fiber material via at least one web and otherwise separating it from the continuous sheet via at least one stress-easing cut; a reshaping ratio, as the ratio of the diameter and the depth, of greater than 0.2 can be realized.

### CROSS REFERENCE TO RELATED APPLICATIONS

This application is the U.S. national stage of International Application No. PCT/DE2015/100175, filed on 2015 Apr. 30. The international application claims the priority of DE 102014106427.5 filed on 2014 May 2008; all applications are incorporated by reference herein in their entirety.

### BACKGROUND

The invention relates to a method and a device for producing three-dimensional molded parts from a continuous sheet of a flat, plastically malleable fiber material. In particular, fleece, paper, paperboard or cardboard can be reshaped into a molded part via a reshaping process similar to the deep drawing of sheet metal (just called deep drawing below).

The application potential of the materials is exhausted with the multi-dimensional reshaping in the case of metals and plastics. In the case of fleece, paper, paperboard and cardboard, multi-dimensional reshaping with a low reshaping ratios based on stamping has been common up to now. In contrast, the drawing process has a high level of potential for the production of hollow bodies that are closed on one side with high reshaping ratios; it has only been used in peripheral areas up to now, however, and there is a low level of scientifically established knowledge. The reason for this is the reshaping behavior of the material. A flowable state as in the case of plastics and metals is not achieved. In practice, the risk of further development or the use of innovative geometric shapes is too high as long as there is no scientific basis for the geometric possibilities that would ensure an application with a reliable process. Drawing machines are designed for simple formats in terms of their manner of operation, and the potential of the drawing process is not fully taken advantage of with respect to the quality of the molded parts, the design and the flexibility of machines. (Hauptmann, M. 2010: Die gezielte Prozessführung and Möglichkeiten zur Prozessüberwachung beim mehrdimensionalen Umformen von Karton durch Ziehen. [Targeted Process Control and Possibilities for Process Monitoring with Regard to the Multi-Dimensional Reshaping of Paperboard via Drawing.] Dresden: Dissertation TU Dresden, 2010.)

At present, a cut-to-size section with a suitable size and shape whose edges are dimensioned in such a way that the material develops folds in the outer surface when it is pulled into the die by the stamp, and therefore has less area than the cut-to-size section, is fed into the manufacturing process in the case of the deep-drawing process. The original area is reduced because of the folding. A process of this type is known from the document DE 176 1 002 B, as an example.

Since the cut-to-size section can be easily pulled into the gap between the stamp and the die with the stamp movement, there is only minor tensile stress on the base of the molded part to be produced. To obtain the cut-to-size section, it is cut to size out of the continuous sheet of paperboard beforehand in an additional process step and has to be made available and prepared for the subsequent deep drawing via the corresponding handling and storage equipment.

Methods are also known in the prior art that make reshaping directly from the continuous sheet of paperboard possible without a prior cutting-to-size step. The documents DE 692 2 1490 T2 and DE 20 2012 102 550 U1 are cited as examples of this. Coated paperboard that has a higher level of tensile strength is used here. Furthermore, special paperboard is known that is costly, but likewise has a higher level of tensile strength. But despite these measures, only reshaping ratios (ratio of the diameter to the depth of the reshaped area) of 0.15 to 0.2 have been possible in the prior art with the reshaping process. Higher reshaping ratios fail because the material associated with the continuous sheet is unable to get to the gap between the stamp and the die without additional tensile forces. The tensile forces that consequently result, which above all have an effect on the material in the area of the base of the molded part, lead to cracks in the material. It namely only permits elongation of 3% to 6%; after that a rupture occurs. The molded part becomes useless because of that. The above-mentioned figures were taken from the book Hesse, Fritz and Hans-Jürgen Tenzer, Grundlagen der Papierverarbeitung. Band 1 bis 3 [Fundamentals of Paper Processing. Volumes 1 to 3], Fachbuchverlag, 1966.

### SUMMARY

The invention relates to a method and a device for producing three-dimensional molded parts from a continuous sheet of a flat, plastically malleable fiber material via deep drawing with a stamp and an associated die, wherein the fiber material between the stamp and the die can be reshaped via a relative movement.

The object of the instant invention is to offer a method and a device for producing three-dimensional molded parts in which the reshaping is done via deep drawing from a cut-to-size section in the continuous sheet and which leads to a high reshaping ratio.

The problem is solved by connecting the round, rectangular, oval or irregular cut-to-size section for the molded part during the deep-drawing process to the continuous sheet of fiber material via at least one web and otherwise separating it from the continuous sheet via at least one stress-easing cut; a reshaping ratio, as the ratio of the diameter and the depth, of greater than 0.2 can be realized.

### DETAILED DESCRIPTION

The object of the instant invention is to therefore offer a method and a device for producing three-dimensional molded parts from a fiber material in which the reshaping is carried out by deep drawing a raw piece that is in the continuous sheet of the material, which leads to a high reshaping ratio.

The problem is solved via a method for producing three-dimensional molded parts from a continuous sheet of a flat, plastically malleable fiber material via deep drawing with a stamp and an associated drawing case. A fiber material customarily has a low level of tensile strength but, on the other hand, is subject to a high level of friction because of strong compression in the clearance. High levels of stress therefore act on the material when it is pulled into the gap between the stamp and the drawing case, which leads to a rupture of the material.

The fiber material can be reshaped via a relative movement between the stamp and the drawing case. The specific allowance or even control of this compensation movement ensures that the material can be reshaped without being held back at the sheet level and thus acquiring expansion cracks. A round, rectangular, oval or irregular cut-to-size section for the molded part is connected during the deep-drawing process with the continuous sheet of fiber material of a different grammage here via at least one web and is otherwise separated from the continuous sheet via at least one stress-easing cut; a reshaping ratio, as the ratio of the diameter and the depth, of greater than 0.2 can be realized.

The advantages of deep drawing an individual cut-to-size section, in which high reshaping ratios can already be obtained according to the prior art, is therefore combined with the advantages of processing a continuous sheet, i.e. a flat material that can be fed into the process in a more or less endless fashion. Continuous-sheet material can usually only be reshaped to a slight degree, namely with reshaping ratios of 0.15 to 0.2. Stamping processes instead of deep-drawing processes are essentially carried out with reshaping ratios around 0.05, however. This drawback is overcome by the invention. The material existing in the form of a continuous sheet makes very simple handling possible, because a manipulation of individual cut-to-size sections is not necessary. That is especially interesting for cut-to-size sections that are not rotationally symmetrical, which have to be put into a precise position in every axis before the deep-drawing process can start.

Furthermore, the connection to the continuous sheet that still exists can also be used for subsequent process steps that follow the shaping via deep drawing. The molded part that is created can be easily transported and put into a precise position without further expenditures being required for this. The molded part, designed in the form of packaging material, can be filled and closed, for instance.

Fleece, paper, paperboard or cardboard are intended to be used as the flat, plastically malleable fiber material in the preferred embodiment of the invention. Good shaping is ensured with these materials, especially in the case of paper and paperboard, even if special materials whose characteristics are specifically geared towards the deep drawing are not used. Moreover, paper and paperboard are especially suitable for use as a product with sufficient stability after the deep-drawing process, for instance as packaging material for packing other products.

It has been shown in an especially advantageous way that high reshaping ratios up to 0.9 can be realized via the deep-drawing process according to the invention. This is only possible according to the prior art if separate cut-to-size sections, completely separated from a material association, are individually fed into the deep-drawing process. As a special preference, reshaping ratios of 0.6 to 0.8 can be realized according to the invention.

Further advantages result from the fact that multi-part packaging components can be produced. It is then no longer necessary to produce these components in individual manufacturing steps and to subsequently combine them with one another, including the handling steps that are required in each case with which they would have to be brought into the position vis-a-vis one another that is required for the connection.

A lower tray, an upper tray and a hinge movably connecting a lower tray and an upper tray can be manufactured in connection with this, as an example. Because of the hinge, the upper tray can be folded over and the entire molded part can be closed later on, for instance after filling the lower tray. An application of this type would especially be advantageous in the area of packaging.

The deep-drawing process is preferably carried out in a closed process in accordance with the invention. In so doing, the molded part is ejected from the drawing case in the opposite direction after the deep-drawing process, in which the cut-to-size section is pressed by the stamp into the drawing case. The molded part can continue to maintain a connection with the continuous sheet after its production because of that and can be fed into a further handling process or subsequent process steps in accordance with the above-mentioned possibilities.

If, on the other hand, the open process is applied, in which the molded part that is produced is ejected from the drawing case in the same direction as the one in which the stamp pressed in the cut-to-size section, the connection to the continuous sheet has to be previously separated. This can be done by completely cutting out the cut-to-size section before the deep-drawing process and would be useful, for instance, when the deep-drawing process is simultaneously the final manufacturing step and no further process steps have to follow.

Special advantages are associated with a compensation movement that can either be carried out as a passive compensation movement in which the continuous sheet is free to subsequently move along during the reshaping process or as an active compensation movement in which the stamp and the drawing case are moved in such a way during the reshaping process that they can be carried along with the shifting of the center point during the transition from the cut-to-size section to the molded part with respect to the center point of the stress-easing cut. Both variants can also be used in parallel. The compensation movement serves to provide a free flow of material during the reshaping. Molded parts with a symmetrical depth cannot be manufactured without this compensation movement. The compensation movement is prevented when the continuous sheet is held in place relative to the tools. This leads to molded parts with uneven heights or a breakaway from the web.

Special advantages result from the invention in the case that the deep-drawing process is carried out on a shaping, filling and closing machine and the steps of manufacturing the molded part in the form of packaging materials or a container, transport of the continuous sheet with the containers to the filling device, filling the container, transport of the continuous sheet with the containers to the closing device, closing of the container, separation of the individual containers or units from the continuous sheet can simultaneously be carried out at various stations. Handling of the molded parts and the packaging that arises can then be carried out in a simple way on the remaining continuous-sheet material, for instance at its edge, as already described above. The molded parts and, later on, the packaging will remain in a defined position and do not have to be handled to be able to carry out the subsequent process steps. Once the packaging has been manufactured, the connection of the individual packs to the continuous material sheet can be detached, either individually or in groups, in accordance with the requirements of the subsequent logistics processes.

The object of the invention is additionally fulfilled via a device for carrying out a deep-drawing process for a flat, plastically malleable fiber material in accordance with the invention described above. This device is comprised of a deep-drawing device, as is known in the prior art for fiber materials, and a cutting device connected to it in a process-related way. The cutting device serves to cut or stamp in one or more stress-easing cuts; one or more webs will remain via which the cut-to-size section remains in connection with the continuous sheet. The cutting device can be directly arranged on the deep-drawing device and can cut the continuous-sheet material in the same position in which the deep drawing is subsequently done. The continuous sheet is therefore not moved further between the two process steps, which could immediately follow one another.

Alternatively, there are provisions with regard to this for the cutting device to be spaced apart from the deep-drawing device so that the cutting is first carried out, the continuous material sheet is then transported to a further process step until it gets to the deep-drawing device so that the deep-drawing process can be carried out there.

The object of the invention is, moreover, fulfilled by a shaping, filling and closing machine having at least one of the previously described shaping devices, in particular deep-drawing devices. The deep-drawing device is arranged in realized in such a way that it will shape containers that are open at the top in the form of molded parts from a continuous sheet of flat, plastically malleable fiber material. The shaping, filling and closing machine will have at least one filling device that is arranged and designed in such a way that it will fill the containers open at the top. Moreover, it has at least one closing device that is arranged and designed in such a way that it will close the open tops of the filled containers. Furthermore, a transport or container-transport device is provided that is designed in such a way that it conveys the continuous sheet, which extends past the shaping device, the filling device and the closing device, wherein the shaping, filling and closing machine also has a separation device that is designed and arranged in such a way that it separates the webs to the effect that individual containers or units of several containers are thereby cut out of the continuous sheet.

Another advantage of the invention is that the machine activity can be continuously used because different process stages exist when there are several deep-drawing stamps that plunge into the drawing case at different times. That is especially advantageous because the greatest amount of force has to be applied at the beginning of the deep-drawing process when there is deep drawing of fleece, paper, paperboard or cardboard.

### BRIEF DESCRIPTION OF THE DRAWINGS

Further details, features and advantages of the invention result from the description below of examples with reference to the accompanying drawings. The following are shown in the figures:

FIG. 1: Prior art; results of drawing experiments according to customary methods with a high reshaping ratio with damage in the base area;

FIG. 2: Schematic representation of an embodiment of the reshaping results with the use of the process as per the invention in a top view;

FIG. 3: Schematic representation of an embodiment of the reshaping results with the use of the process as per the invention in a view in perspective;

FIG. 4: Schematic representation of an embodiment of the deep-drawing device as per the invention in a sectional side view;

FIG. 5: Schematic representation of the process steps as per the invention in a sectional view of the reshaping device;

FIG. 6: Schematic representation of a shaping, filling and closing machine with an embodiment of the reshaping device as per the invention; and

FIG. 7: The process flow and operation of the compensation movement.

### DETAILED DESCRIPTION OF THE PREFERRED EMBODIMENTS

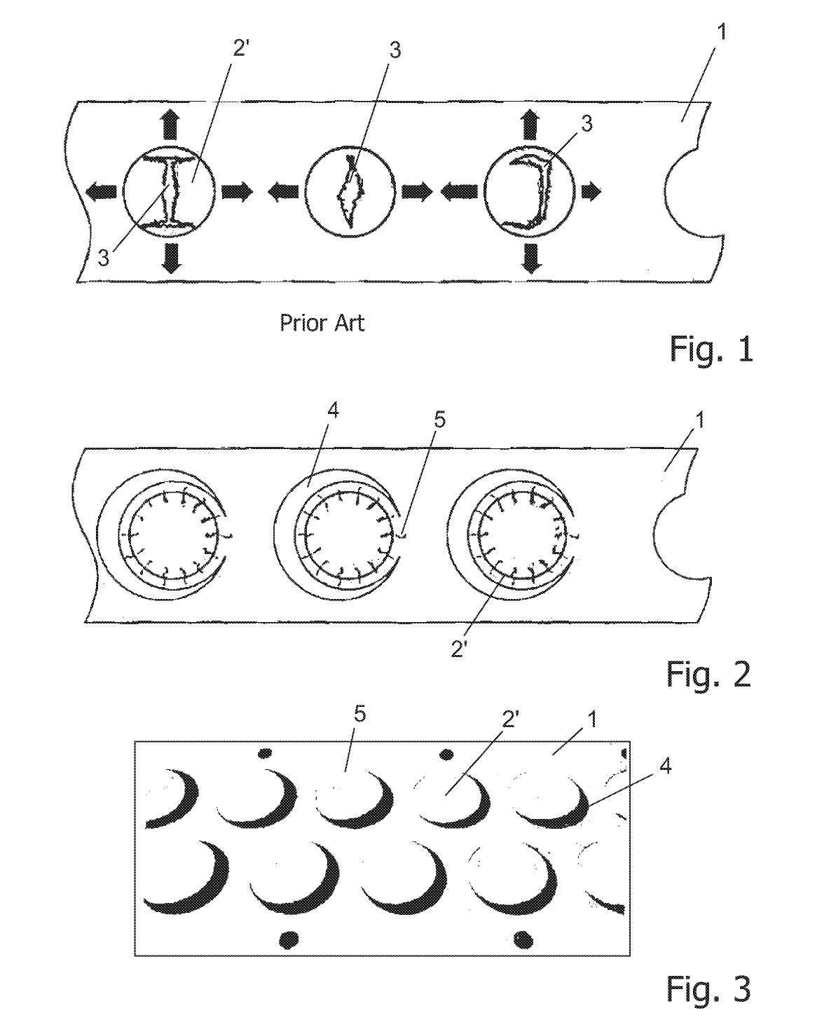

FIG. 1 shows the prior art with results of drawing experiments according to customary methods with a high reshaping ratio with damage to the base area that arises because of that. A free and largely unhampered movement of material into the clearance is not possible or is only possible when fairly high forces are overcome because of the complete connection of the molded part to the continuous sheet 1 that also exists during the drawing process. The result is excess stresses on the material from pulling; a rupture 3 of the material bond comes about, and the molded part 2′ becomes useless because of that. Different variants of ruptures 3 in the base area are shown. Ruptures 3 in the wall of the fiber material can likewise come about, because the greatest stresses specifically arise there when deep drawing fiber materials, always in dependence upon coefficients of friction between the stamp and the fiber material, for instance paperboard.

FIG. 2 shows a schematic representation of an embodiment of the reshaping results with the use of the process as per the invention in a top view. Molded parts 2′ that are still connected to the continuous sheet 1 via a web 5 are formed via deep drawing in the process. The other areas where the cut-to-size section for the molded part 2′ was originally connected to the continuous sheet 1 are separated with a stress-easing cut 4. The material of the continuous sheet 1 was pulled into the clearance there without obstruction during the deep-drawing process, so a flawless molded part 2′ was able to be formed.

FIG. 3 shows a schematic representation of an embodiment of the reshaping results with the use of the process as per the invention in a perspective view.

Molded parts 2′ are formed in two rows in the continuous sheet 1 in the process. The molded parts are likewise still connected via a web 5 to the continuous sheet 1 and otherwise separated out of the continuous sheet 1 via stress-easing cuts.

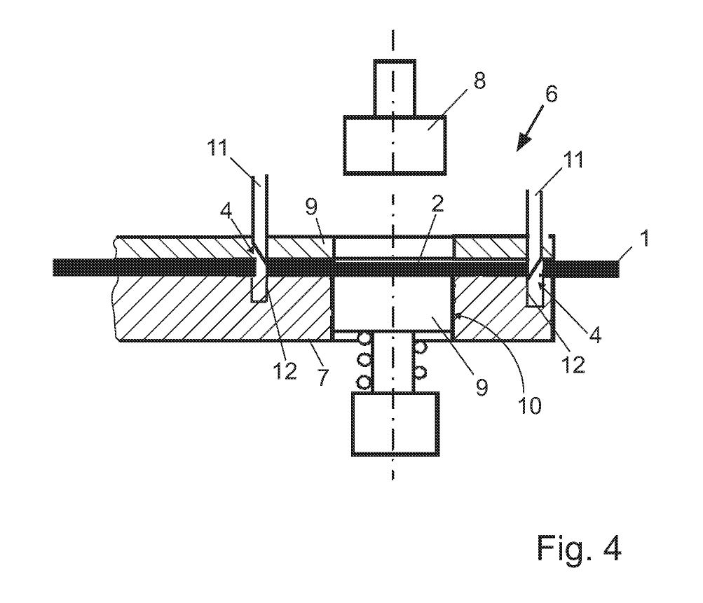

FIG. 4 shows a schematic representation of an embodiment of the deep-drawing device 6 as per the invention in a sectional side view. The continuous sheet 1 lies in the deep-drawing device 6 in such a way here that it covers the opening of the drawing case 7. The cutting devices 11 that make at least one stress-easing cut 4 in the continuous sheet 1 in collaboration with the opposing blades 12 are provided to obtain a suitable cut-to-size section 2. When the stamp 8 drops into the drawing case 7 during the subsequent deep-drawing process, which is not shown here, the cut-to-size section 2 can be put for shaping into the clearance between the drawing case 7 and the stamp 8 with virtually no obstructions because of that.

First off, however, the cut-to-size section 2 is fixed in place with the blank holder 9, which presses against the drawing case 7, to the extent that the cut-to-size section 2 is pulled into the clearance against a defined frictional force and without excessive folding. When the molded part has been created, the counter support 13 ejects it in the direction of the stamp 8, which has left the drawing case 7 again in the meanwhile in a direction opposite to the reshaping direction.

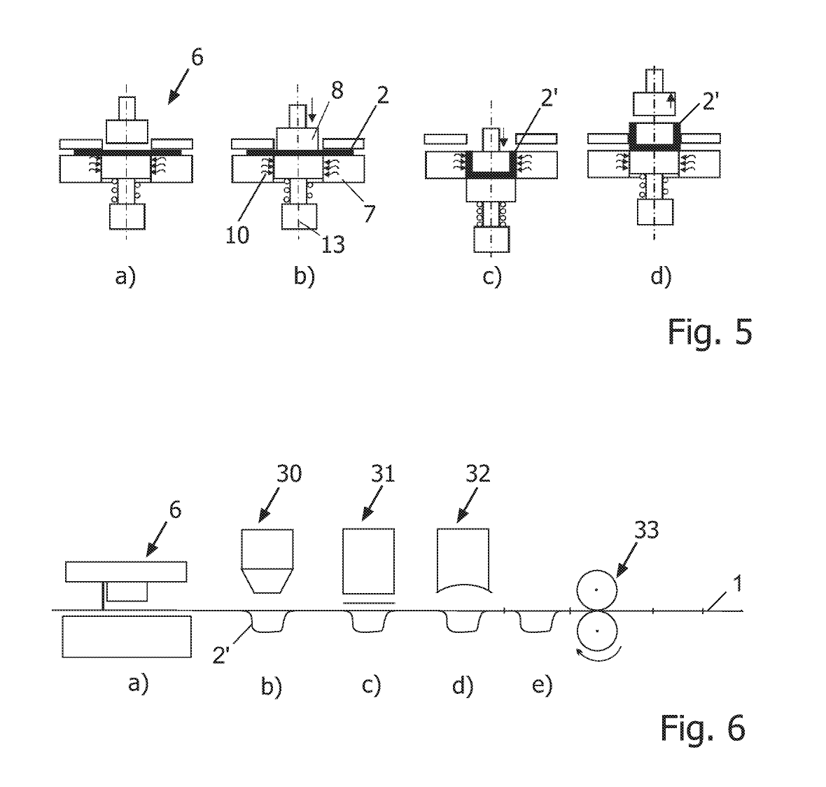

FIG. 5 shows a schematic representation of an embodiment of the method steps as per the invention via sectional views of the reshaping device 6, but without the cutting devices 11, 12 here. They are not directly arranged on the deep-drawing device 6 in the embodiment that is shown, but instead have their effect in an upstream process step. The continuous sheet 1 therefore reaches the reshaping device 6 with stress-easing cuts that have already been made in process step a), but they are not visible in the presentation that was chosen.

The stamp 8 moves onto the cut-to-size section 2 in the direction of the arrow in process step b). A heater 10 heats the drawing case 7. The actual reshaping process takes place in process step c); the stamp 8 is lowered further in the direction of the arrow, and presses the cut-to-size section 2 into the drawing case 7. The molded part 2′ that has now been formed is fixed in terms of its shape via the heat treatment. Finally, the removal from the mold follows, as represented in process step d), in that the counter support 13 ejects the fixed molded part 2′ from the mold, the drawing case 7.

FIG. 6 shows a schematic representation of a shaping, filling and closing machine with an embodiment of the reshaping device 6 as per the invention. The molded part 2′ is formed in the process in process step a) with the aid of a deep-drawing device 6 as per the invention. The molded part 2′ is designed in the form of packaging material here. It is filled with the goods to be packed via the filling device 30 in process step b). Process step c) follows here, in which a closure is fastened on the molded part 2′ via the closing device 31.

Up to that point, the packaging that has now been formed is still connected to the continuous sheet 1, which ensures easier handling and exact positioning. The packaging has to be separated from the continuous sheet 1, however, to prepare it for delivery. This takes place in a further station, the separation device 32. An individual instance of packaging or, as necessary, grouped packaging therefore exists at this point in process step e) that can be removed and prepared for shipping or for the required follow-up logistical handling.

The continuous sheet 1 is transported via a transport device 33, and the molded part 2′ is therefore conveyed from station to station, as described above.

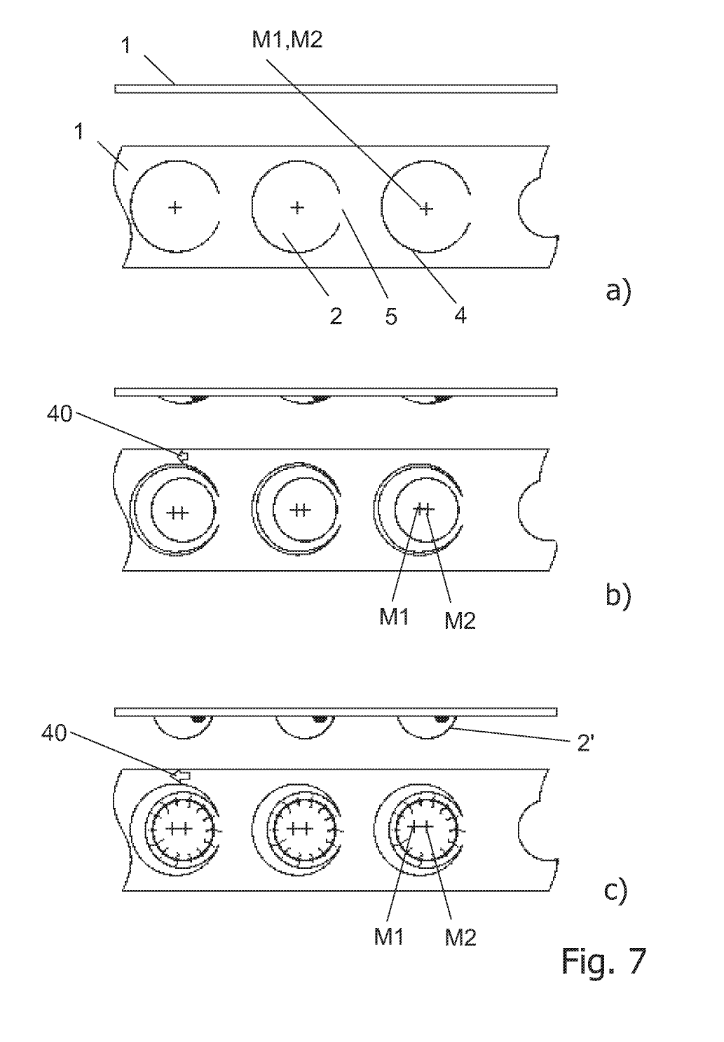

FIG. 7 shows the process flow and operation of the passive compensation movement during deep drawing with a starting state a), an intermediate state b) and an end state c), in a side view and top view in each case. The continuous sheet 1 with the cut-to-size sections 2 and later the molded part 2′ can be recognized here; the latter is connected to the continuous sheet 1 with the web 5.

Although the center point M1 of the stress-easing cut 4 coincides before the reshaping with the center point M2 of the (future) molded part 2′, this changes during the reshaping when material of the cut-to-size section 2 is pulled into the clearance. Since the molded part is fixed in place on one side in the continuous sheet through the web, the material flow only takes place on one side in the process, so the continuous sheet has to either be free, in order to subsequently move along by the amount of the compensation movement 40 (passive, as shown), or the tools, thus the stamp and the drawing case, have to be moved in such a way that they are carried along with the shift in the center point (active compensation movement, not shown).

### LIST OF REFERENCE NUMERALS

1 Continuous sheet
2 Cut-to-size section for the molded part
2′ Molded part
3 Rupture
4 Stress-easing cut
5 Web
6 Deep-drawing device
7 Drawing case
8 Stamp
9 Blank holder
10 Heater
11 Cutting device
12 Opposing blade
13 Counter support
30 Filling device
31 Closing device
32 Separation device
33 Transport device
M1 Center point of the stress-easing stamp
M2 Center point of the molded part
40 Passive compensation movement

1. A method for producing three-dimensional molded parts from a continuous sheet of a flat, plastically malleable fiber material via deep drawing with a stamp and an associated drawing case, wherein the fiber material between the stamp and the drawing case can be reshaped via a relative movement, wherein a round, rectangular, oval or irregular cut-to-size section for the molded part is connected during the deep-drawing process with the continuous sheet of fiber material via at least one web and is otherwise separated from the continuous sheet via at least one stress-easing cut, wherein a reshaping ratio, as the ratio of the diameter and the depth, of greater than 0.2 is realized.

2. The method according to claim 1, wherein fleece, paper, paperboard or cardboard is provided as the flat, plastically malleable fiber material.

3. The method according to claim 1, wherein reshaping ratios of 0.3 to 0.9 are realized.

4. The method according to claim 1, wherein reshaping ratios of 0.6 to 0.8 are realized.

5. The method according to claim 1, wherein multi-part packaging components are produced.

6. The method according to claim 5, wherein a lower tray, an upper tray and a hinge movably connecting the lower tray and the upper tray are manufactured in connection with this.

7. The method according to claim 1, wherein the deep drawing is carried out in a closed process.

8. The method according to claim 1, wherein a compensation movement is provided that can be carried out as a passive compensation movement, wherein the continuous sheet is free to subsequently move along during the reshaping process, or/and as an active compensation movement, wherein the stamp and the drawing case are moved in such a way during the reshaping process that they can be carried along with the shifting of a center point M2 during the transition from the cut-to-size section to the molded part with respect to a center point M1 of the stress-easing cut.

9. The method according to claim 1, wherein the deep drawing is carried out on a shaping, filling and closing machine and the following steps are simultaneously carried out at various stations:
production of the molded part as a container in a deep-drawing device,
transport of the continuous sheet with the containers to a filling device,
filing the container in the filling device,
transport of the continuous sheet with the containers to a closing device,
closing the container in the closing device,
separating the container individually or in units from the continuous sheet in a separation device.

10. A device for producing three-dimensional molded parts from a continuous sheet of a flat, plastically malleable fiber material via deep drawing, comprised of a stamp and an associated drawing case, which form a deep-drawing device wherein the fiber material between the stamp and the drawing case is reshaped via a relative movement of the stamp and drawing case, wherein the deep-drawing device and a cutting device connected to it in a process-related way are provided, wherein a round, rectangular, oval or irregular cut-to-size section for the molded part is cut out of the continuous sheet (1) made of fiber material via at least one stress-easing cut with the cutting device in such a way that the cut-to-size section remains connected via at least one web to the continuous sheet and is otherwise separated from the continuous sheet via the stress-easing cut.

11. The device according to claim 10, wherein the deep-drawing device is arranged in the area of the cutting device so that the continuous sheet is cut and the deep drawing is subsequently done without the continuous sheet being moved further.

12. The device according to claim 10, wherein the deep-drawing device and the cutting device are spaced apart from one another so that a cut-out process takes place at first and the deep drawing follows after further transport of the continuous sheet to the deep-drawing device.

13. A shaping, filling and closing machine having at least one deep-drawing device to create containers open at the top in the form of molded parts, at least one filling device that fills the containers that are open at the top, at least one closing device that closes the open tops of the filled containers, and a transport device that conveys a continuous sheet, which extends along the deep drawing device, the filling device and the closing device, along the deep drawing device, the filling device and the closing device, wherein the shaping, filling and closing machine also has a separation device that separates webs between the continuous sheet and molded parts in such a way that individual containers or units of several containers are cut out of the continuous sheet, wherein at least one deep-drawing device and at least one cutting device according to claim 10 are provided to create containers in the form of molded parts.
